(19) United States
(12) Patent Application Publication
(10) Pub. No.: US 2007/0185743 A1
(43) Pub. Date: Aug. 9, 2007

(54) System for automated insurance underwriting

(76) Inventor: Jill K. Jinks, Marietta, GA (US)

Correspondence Address: CARLTON FIELDS, PA, 1201 WEST PEACHTREE STREET, 3000 ONE ATLANTIC CENTER, ATLANTA, GA, 30309, US

(21) Appl. No.: 11/710,252

(22) Filed: Feb. 23, 2007

Related U.S. Application Data
(63) Continuation-in-part of application No. 10/008,182, filed on Nov. 9, 2001.
(60) Provisional application No. 60/247,364, filed on Nov. 9, 2000.
(60) Provisional application No. 60/776,020, filed on Feb. 23, 2006.

(51) Int. Cl. G06Q 40/00

(52) U.S. Cl. 705/4

(57) ABSTRACT

There is disclosed a system that enables an efficient and flexible way to provide automated rating and underwriting based on a specific set of rules. The system includes a software running on a centralized or distributed computing system and accessing different databases. The software system can be access by insurance carriers and their agents located in one single location or distributed geographically.

### RELATED APPLICATION

This application claims benefits of the U.S. Provisional Patent Application No. 60/776,020, titled “System For Automated Insurance Underwriting,” filed on Feb. 23, 2006; this application is also a continuation-in-part of a U.S. patent application Ser. No. 10/008,182, titled “System And Method For Interactively Evaluation A commercial Risk Insurance,” filed on Nov. 9, 2001, which claims the benefit of the U.S. Provisional Patent Application, 60/247,364, filed on Nov. 9, 2000. The specifications of three prior applications are incorporated herein in their entirety by this reference.

### BACKGROUND OF THE INVENTION

1. Field Of The Invention

The present invention generally relates to a computer system implementing a process related to the issuance of insurance policies. More specifically, the present invention is an automated system and method for underwriting insurance policies.

2. Description of The Related Arts

Due to changes in the insurance marketplace, it is advantageous to employ an aggressive, competitive initiative in re-positioning insurance products and the internal processing of those products based on a specific set of rules for quoting, underwriting, printing, and administering an insurance policy. Consequently, insurance carriers and their agents must analyze data from various sources and react appropriately. This data analysis from constantly increasing data sources makes the insurance agent's job increasingly difficult and costly.

Therefore, it is desirous to have a system capable of performing automated rating and underwriting based on a specific set of rules that streamlines the process for quoting, underwriting, printing and administering a policy. Such system should access the appropriate database and gather the optional data to improve the ability for insurance carriers and agents to analyze data and react appropriately, and it is to such system and method that this invention is primarily directed.

### SUMMARY OF THE INVENTION

In one embodiment, there is a system for streamlining insurance quoting and underwriting process, the system interfacing with a remote server. The system includes a policy administration module for implementing core policies and client customization and outputting a client policy, a billing module for generating a bill to each client according to the client policy, a claims module for processing claims according to core claims features, and an interface module for sending and receiving information from the remote server. The claims module is further capable of customization according to each individual client policy.

In another embodiment, there is a method for improved insurance quoting and underwriting. The method includes the steps of receiving customer information, customizing customer information according to core policies, outputting a client policy, and generating a bill according to the client policy.

Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 is an architecture of a system according to one embodiment of the invention.

FIG. 2 is an interface architecture between a main application and a client application according to one embodiment of the invention.

FIG. 3 is a flow chart for a client process according to one embodiment of the invention.

### DETAIL DESCRIPTION OF THE INVENTION

In this description, the term “exemplary” means that the disclosed element or embodiment is only an example, and does not indicate any preference of user. Further, like numerals refer to like elements throughout the several views, and the articles “a” and “the” includes plural references, unless otherwise specified in the description.

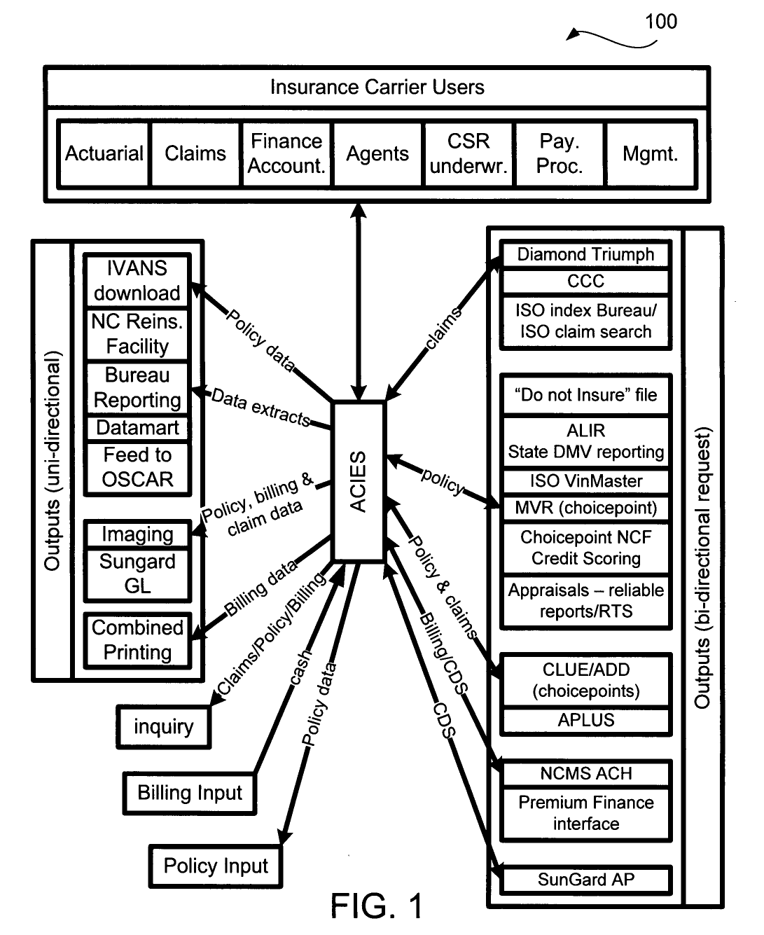

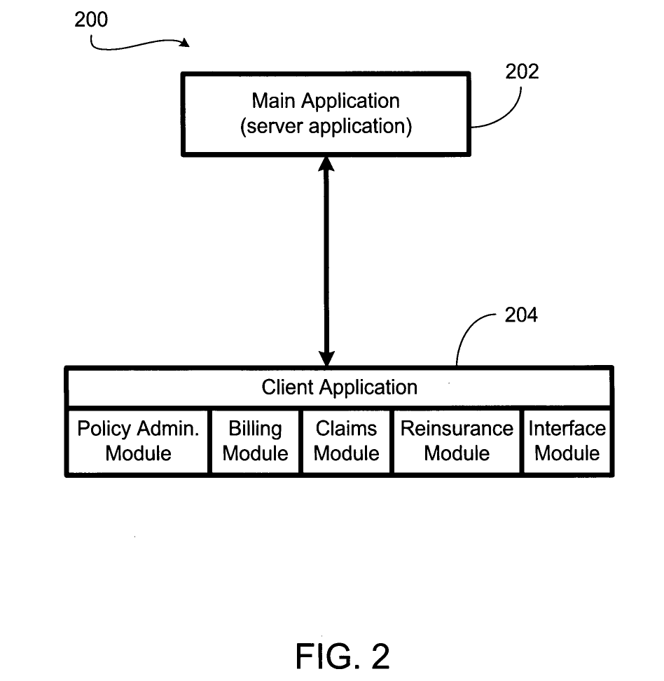

In overview, the system and method enables an efficient and flexible way to provide automated rating and underwriting based on a specific set of rules. The system includes a software running on a centralized or distributed computing system and accessing different databases. The software system can be access by insurance carriers and their agents located in one single location or distributed geographically. FIG. 1 illustrates a system architecture 100 supporting the present invention. The system includes a software-based application interfacing with different system players. The application takes inputs from different databases (policy tables, billing information) and provides outputs to different users in the insurance industry. The system may be a single application or a centralized server application interfacing with different distributed client applications. FIG. 2 illustrates a centralized server application 202 interfacing with a client application 204. The centralized server application is capable of interfacing with more than one client application at the same time. The client application 204 is shown with five internal modules: policy administration module, billing module, claims module, reinsurance module, and interface module.

The server application 202 includes the following features:
1. Tables
   System Tables—Both standard system-defined and user-maintained
   Profiles
   Error Log
   Commission Packages
   Custom Tables (such as Cause of Loss, Bank Account and SURE related tables)
2. Settings
   Application Settings—System settings that incorporate user-defined parameters.
   Number Control—Settings to define the Policy numbering schema selected by the Client
3. Security—User security to be set by function or transaction for all employees entered into User Profile, including agency designation for agency level security settings
4. Direct access to the Policy, Billing, Claims and Cash Disbursement modules
5. Name and Address Search—Ability to access information by name or address
6. Account Reference View—Ability to view Notes, Diary, Tasks, Policy Activity, Policy Action, Policy Log and Suspended Transactions for all policies linked by a user established Account Reference Number.
7. Locality Search (Mapping Software)—Ability to view geographic location of a risk based on address
8. View of Policy Activity, Policy Action, Policy Log and System Action
9. Diary—Ability to enter and view diary entries at an account, policy, claim or claimant level.
10. Notes—Ability to enter and view Notes at an account, policy, claim or claimant level.
11. Task Pad—Ability to enter, display and maintain user tasks
12. Reports—On-demand and scheduled report generation for all systems supplied reports
13. Agency Transfer—Ability to transfer individual policies or an Agency's book of business to another agency.
14. Bulk Lien Holder Transfer—Ability to transfer policies from an existing Additional Interest profile to a new profile.
15. Word Merge (works with Microsoft Word)—Ability to merge pre-defined system information into user created Word templates
16. SURE launch pad and rule establishment
17. Auto Renewal/Non-renew rule creation and editing—Ability for user to enter and maintain processing rules regarding the generation of renewals and non-renewals
18. Prorata calculation tool—Calculates factor based on entered effective and expiration dates.
19.Account Reference Link—Ability for a user to set up an account to link policies in the system together
20.View Rating Tables
21. Suspended Transaction Table
22. Purge—Ability to purge both Quote and Diary entries
23. XML View—Ability to view policy XML generated by the system
24. On-line Help System

The Policy Administration Module (also known as policy rating and issuance module) includes core policy features and client policy customizations.

The core policy features include:

1. Policy processing including the following policy transactions:
   a. Quote Processing
      i. Incomplete Quote
      ii. Issue Quote
      iii. Amend Quote
      iv. Quote As (iterative quoting)
      v. Reject Quote
   b. Application Processing
      i. Issue Application
      ii. Amend Application
      iii. Decline Application
      iv. Application As (iterative applications)
   c. Binder Issuance
   d. New Business Issuance
   e. Amendment Processing
      i. Sequential amendments
      ii. Out of Sequence Amendments
      iii. Cross Term Amendments
   f. Cancellation Processing
      i. Flat
      ii. Pro rata
      iii. Short rate
      iv. Equity based
      v. Cancellations imported from ancillary source
   g. Reinstatement Processing
      i. Flat
      ii. Pro rata
      iii. Short rate
      iv. Reinstate with lapse
   h. Renewal Quote
      i. Amend renewal quote
      ii. Issue renewal quote
   i. Renewal Issuance
      i. Manual renewal
      ii. Automated renewal
   j. Cancel/Rewrite Processing (i.e. policy is cancelled flat, new quote is created, user updates quote and updated quote is re-issued with original policy number)
2. Automated rating including the following features:
   a. On screen viewing, printing, faxing and exporting of Rating Worksheets showing summary, pro rata and detail premium calculations.
   b. Automatic generation of quote, application, binder and policy number according to client specifications.
   c. “Soft” and “hard” underwriting edits (as specified in Business Design Specifications)
   d. Drop down menus for selections and default settings.
   e. “Required field” edits by policy transaction
   f. Multi-location quoting/rating (as specified in Detail Business Requirements)
   g. Honoring of quotes restricted by date
   h. Calculation of premium adjustments including taxes, acquisition fees, surcharges, discounts and state pool assignments
   i. Ability to exclude drivers on auto policies
   j. Ability to assign a pay plan to a policy
   k. Ability to override agency commission on a per policy and/or line of business basis
1. Ability to handle various policy terms (as specified in the Detail Business Requirements)
   m. Reinsurance indicators within the policy module to process applicable reinsurance
3. Policy output declarations (as specified in the Detail Business Requirements)
4. Policy History (View, print or inquire against multiple historical versions of the policy)
5. Policy Actions (non-amendment updates to policies)
   a. Inspection Tracking
   b. Underwriter assignment/status
6. SURE (System Underwriting Rules Enforcer)
   a. User configured and maintained underwriting rule tables
   b. Manual and automated application of rules
   c. Activity results and reports
      The client policy customizations include:
1. Automated application of multiple rate plans and program tiers (based on requirements study)
2. Automated application of multiple rate revisions (as specified in the Detailed Business Requirements)
3. Generation of policy forms and notices
4. Customer Service Inquiry Screen
5. Support for multiple underwriting companies.

The Billing Module includes the following baseline functionalities and features.

Core Billing Features:

1. Agency Billing Functionality
   a. Account Current Statements (as specified in the detail client requirements) generated according to client configuration
   b. Flexible Cash application
   c. Unmatched Cash acceptance
   d. On-line view of agency billed policies and cash applied
   e. Write Off capabilities
2. Direct Billing Functionality
   a. Automatic assignment of pay plan and application of fees
   b. Override pay plan and due date utility
   c. Automatic generation of bills and notices (output to be specified in detail client requirements)
   d. Reprint Bills
   e. Manually generated bills
   f. Stand alone billing for amendments
   g. Flexible cash input and application
   h. Unmatched cash acceptance
   i. Payments Inquiry
   j. Equity cancellation
   k. Billing Inquiry
   I. Automated tolerance and manual write off
   m. Automatic non-payment cancellation notification to policy administration system
   n. Agency Commission Statements
   o. Non-Sufficient Funds (NSF) charge for returned checks
   p. Late payment fees
   q. Balance Brought Forward (BBF) at renewal
3. Account Billing Functionality
   a. Generation of invoices by Account (output to be specified in Business Design Specifications)
   b. Billing Inquiry by Account
4. Interface with Cash Disbursement System (CDS) for creation of checks
   a. Agency Commission Checks (output to be specified in the detail client specifications)
   b. Return Premium Checks (output to be specified in the detail client specifications)
5. Assignment of General Ledger Accounts at the Line of Business level
6. Client configured option tables scoped by Company, State, Product, Program and Bill Type where applicable
7. User/administrator control of invoice and report generation
   Client Billing Customizations:
1. Electronic Funds Transfer (EFT) (See Interface Module)
2. Non Sufficient Funds (NSF)
   a. Processing of NSF checks in accordance with Insurance Carrier business rules
3. Lockbox Processing (See Interface Module)
4. Additional flexibility in the application of installment fees
6. Selection of repetitive monthly due date
7. First installment surcharge
8. Application of cash in order of fees, premium and surcharges (if any)
9. All date fields must offer calendar date selection

The Claims Module includes the following baseline functionalities and features.

Core Claims Features:

1. New Claims processing
   a. Policy verification
   b. Capture of:
      i. First notice of loss information
      ii. Claimant information
      iii. Loss description including location
      iv. Parties to Loss information
   c. Catastrophe Tracking
   d. Service Provider selection
   e. Claims Professional assignment
   f. Line of business and cause of loss assignment
   g. Reserve assignment (including averaging and defaults according to client configuration)
   h. “Record only” claims
2. Loss Summary entry for bulk transaction recording
3. Payment processing including the following transactions
   a. Scheduled recursive payments
   b. Deferred Payments—combine payment transactions across multiple claims for a single payee
   c. Consolidated Payments—consolidate payments within a claim into a single payment
   d. Partial Payments (both reducing reserves and not affecting reserves)
   e. First and Final Payments
   f. Closing Payments
   g. Closing Without Payments
   h. No payment (recording payment without creating an accounting transaction)
   i. Void payment reserve reinstate
   j. Void payment no reserve reinstate
4. Salvage and subrogation at LOB level
   a. Description, total estimated value, estimated cost of recovery, etc.
   b. Salvor information
   c. Salvage Item schedule
   d. Salvage owner information
   e. Salvage reserve entry for salvage expense reserving, salvage expense payments (e.g.: fees), and salvage recoveries.
   f. Tortfeasors information (subrogation only)
   g. Other insurance information (subrogation only)
5. Litigation tracking
   a. Capture details including:
      i. Litigation type, dates filed, served, hearing, etc.
      ii. Litigation attorney information
      iii. Court information
      iv. Litigation service providers
      v. Settlement offers
      vi. Judgment information
6. Activity log at each level of claim
7. Claims Inquiry
8. Display of Claims based on various fields such as policy, insured, etc.
9. Claim screen navigation via the Claim Center
10. Interface to Cash Disbursement System (CDS) for manual and automated check writing (as documented in the detail client specifications)
11. Client configured authority access and authority amount permissions tables
12. Capture of 1099 Information
   Client Claim Customizations:
1. Modify the granting of authority override limits from that of a claim level to that of a transaction level
2. Default to “check” option for all entries where check/draft appear
3. Remove the option for “record only” claims
4. Make “city” a mandatory field for accident and claimant addresses
5. Report date, at all hierarchical levels, is to default to the current date

The Reinsurance Module includes the following baseline functionalities and features:
1. XML Based messaging for modularity.
2. User maintainable tables include:
   a. Reinsurance Companies
   b. Broker/Reinsurance Intermediaries
   c. Treaty Reinsurance Contracts
   d. Facultative Reinsurance Contracts
   e. Treaty Participant Schedules
   f. Schedule of Approved Facultative Reinsurers
   g. Broker/Reinsurance Commissions
3. Handles ceded reinsurance contracts.
4. Facultative Reinsurance handling system.
5. Facultative certificate information can be enforced from Policy System.
6. Facultative and other forms of reinsurance are evaluated for claims processing.
7. Automatically cedes premium for Facultative, Quota Share, Surplus Share and other types of pro-rata treaty reinsurance
8. Maintains the minimum and deposit premium information for Excess of Loss and Catastrophe reinsurance
9. Provides accounting reports for tracking the actual Excess of Loss premium
10. Able to flexibly handle multiple levels of reinsurance protection based on the contract criteria and processing hierarchy. i.e. combinations of Facultative, Pro-rata and Excess of Loss contracts protecting the same risk at different levels
11. Automatically cedes Loss Reserves and Paid Loss and LAE for all types of reinsurance
12. Checks all claim transactions for associated reinsurance
13. Generates periodic premium and loss bordereaux reports (optional)
14. Generates Notice of Loss, Proof of Loss and Ceded Reserve Change forms
15. Maintains aged reinsurance balances at the participant level
16. Maintains all data necessary to produce Schedule “F”
17. Portfolio Transfers feature (optional)
18. Processes Run-offs
19. Facilitates Commutation activity support
20. Ceded transactions are maintained at the detail level for reporting and auditing.
21. Balancing and edit controls.
22. Allows for manual entry of reinsurance

The Interface Module includes the following client features:
1. IVANS Download—Two stage process. First stage is getting the legacy systems to feed the Download for Personal Auto (separate Statement of Work) and then implement the download through once PPA is in production. The next stage would include the downloading of Property (HO, MH & DF) once these lines are in production in the system. It would include certifications for Applied, AMS AFW, AMS Prime, Doris and Agency Advantage.
2. Combined Printing Interface—The ability to receive XML based files which contain information from multiple sources and combine data onto a single A/C Statement, Commission Statement or bill when there is specified matched criteria. Phase I of this interface is being handled under a separate Statement of Work and will combine multiple sources of data within existing IH (insurance carrier) systems. Phase II will include source data as part of combined printing.
3. Feed to OSCAR—A monthly extract of name entity data from will be provided that will be processed by the OSCAR System for the purpose of automated verification of named entities against the current OFAC/SDN list.
4. Imaging Interface—Multi-phase project. Phase I will be the transmittal of Declarations for policy transactions to the Imaging system with the appropriate indexes. (Billing and Claims imaging requirements will be handled under a separate SOW or Change Request.)
5. Web PPA Rating: IDP will provide a replacement for the this product will be the acceptance of data input in the Accuauto comparative rating product through a “bridge” that IDP will provide.

The Web PPA product will allow agencies to rate and issue policies fed directly into the system as well as provide MVR, Credit Score, ADD, CLUE, and APLUS reporting capabilities.
6. ALIR (Automobile Liability Insurance Reporting) (GA, NC, DC, VA & SC)—Using the IVANS ALIR software, IDP shall translate insurance transactions including new business, cancellation and error/verification into the proprietary state format and transmit it via SFTP. Errors reported by the DMV will be handled by insurance carrier personnel.
7. ALIR Error Reporting to Agencies—ISP shall produce a report to present the errors returned from the ALIR reporting
8. ChoicePoint (Scorecard)—
   a. MVR (Motor Vehicle Reports): order MVRs from ChoicePoint for policies upon request and upon renewal, and store the rating data elements with the policy. The text of all the data returned with the MVR shall be stored and available for viewing in a text format.
   b. Credit Score: order Credit Scores from ChoicePoint for policies upon request and upon renewal, and store the rating data elements with the policy. The text of all the data returned with the Credit Score will be stored and available for viewing in a text format.
   c. ADD (Additional Driver Discovery): order Additional Driver Discovery data from ChoicePoint for policies upon request and upon renewal. The text of all the data returned with the ADD will be stored and available for viewing in text format.
9. CLUE (Comprehensive Loss Underwriting Exchange)—Monthly feed of Claims data to CLUE
10. CLUE—Accessing CLUE reports from within the Policy Tree during Auto and Property policy entry
11. Aplus (Automobile-Property Loss Underwriting Service)—Monthly feed of Claims data to Aplus
12. Aplus—Accessing APLUS reports from within the Policy Tree during Auto and Property policy entry
13. ISO (Insurance Services Organization) VinMaster—For the supplemental files and years that Insurance Carrier has licensed from ISO, IDP shall return Vehicle Series Rating symbol based upon the VIN (Vehicle Identification Number) entered. A VIN/Symbol lookup feature will also be available.
14. Sungard (GL Feed)—IDP shall provide an XML to the Sungard General Ledger package which will provide the information necessary to record financial transactions.
15. Sungard AP—IDP will provide a feed from the CDS (Cash Disbursement System) to the Sungard AP System for Billing and Claims checks.
16. Agent Bank Account Sweeps (Two phase project)—Phase I shall be creating an input file in the Cash Input XML format of payments entered via the web rating application, and providing a payment file to be processed through the IH cash sweeping mechanism.
17. Feed to Datamart—An extract of standard policy and claims XML will be provided to feed the insurance carrier datamart.
18. Do Not Insure file-A file containing Names and reasons for not wanting to insure someone. Names will have effective/expiration dates and a notes field. The names will be checked when name entities are entered into the Policy system
19. NCMS (National Cash Management Systems) ACH (Automatic Clearing Carrier)—Electronic transfer of funds including credit card, check and debit processing, for Account Current (A/C) and Direct Bill (DB) Bill Types.
20. Lockbox—Billing Module will accept the automated import of cash from the designated IH payment processing facility.
21. Web Property Rating: IDP will provide a web product similar to the PPA Rating product for the purpose of agency entry of HO, MH and DF product lines.
22. Appraisals/Inspections (Reliable Reports)—An interface that is provided through Reliable Reports, Inc. They state the following “Reliable Reports, Inc. receives orders from customers in a variety of ways. Many clients order directly through our website. Larger customers send data files. We can support almost any format of data file transfer.”
23. FNOL (First Notice of Loss)—shall accept an electronic import of the First Notice of Loss for all lines of business.
24. ISO Index Bureau—Daily feed of Claims data to bureau.
25. ISO Index Bureau—Accessing Bureau information from within the Claims System
26. Diamond Triumph (Glass loss assignment)—Diamond Triumph entry of all FNOL for glass claims directly into the system with coverage verification.
27. North Carolina Reinsurance Facility—The creation of a daily flat file (80 character, fixed length) that contains Record ID, State & Company Codes, Effective, Expiration & Cession dates, Designated Indicator, Class, BI, PD, MED, UM BI, UM/UIM and UM or UM/UIM PD Limits codes, Transaction Code, Policy number and Insured name.

The Bureau Reporting Services will include full bureau reporting including generation, balancing, edit and correction of required bureau output for premium and loss data processed via the System.

The following optional functions can also be supported by the system:
1. Insurance Carrier's definition of its Business Requirements
2. Creation of Acceptance Test Cases and expected results
3. Acceptance Testing
4. Incorporating changes to the specifications, design, and coding that result from a change in Insurance Carrier's Business Requirements once those Requirements are received.
5. Support for error correction and debugging as a result of Insurance Carrier providing data not in conformance to specifications
6. Conversion of policy, billing, reinsurance or claims data (to be handled under a separate SOW)
7. IVANS Upload (uploading of data from agency management systems)
8. Work effort, resources, and/or costs of Third Party services not specifically included in this document
9. Claims processing associated with claims made policies

The following additional features and options can be made to the present system:
1. Imaging Interface for workflow for policy and claim triggers.
2. Web Portal Presentation Layer that can be coded to be used as a single sign-on, single point of entry for agents into the various systems provided by an insurance carrier.
3. IVR (AGNES)—an extract of policy, billing and claims data to the AGNES database for the purpose of IVR inquiries.
4. Agent Bank Account Sweeps
5. Rules based assignment to adjusters based on line, state and geography.
6. Premium Finance Interface—Cancellation & Reinstatement processing.
7. Claims (CCC Information Services, Inc.)—An interface that is provided through CCC Information Services, Inc. whose headquarters are in Chicago, Ill. They state the following “CCC Autoverse™ provides an open environment enabling the efficient exchange of data between insurers and appraisal sources for quicker claim resolution. The CCC Pathways® Collision Estimating product has nearly 20,000 insurers and repair facilities installations in the U.S. CCC also pioneered value added network communications between the industry participants involved in claims settlement. The EZNet® network handles an average of more than one million claims-related transactions each business day.”
8. Appraisals (RTS)—an interface to RTS to order Commercial Lines inspections.
9. History View—Additional customized feed of billing data to the datamart

The system must be able to process approximately 10,000 claims transactions per month (including opens, closures, adjustments, stop-pays, other). To handle such volume of claim transactions the system has the following input, output, and security requirements. The input requirements, according to one embodiment of the invention, are as follows.
1. Policy data for all lines of business will be input via agency web users and IH data entry personnel for new business, amendment and renewal processing.
2. Web PPA rating system
3. Web Property rating system
4. Payment upload from Agent Account Sweep, Lockbox and EFT Processing

The following output types, volumes and frequencies to be supported.

TABLE 2

| Type of Output | Volume | Frequency |
|---|---|---|
| Billing Notices | 51,000 | Monthly |
| Return Premium | 100-200 | Daily |
| Checks | | |
| Commission Checks | 600+ | Monthly |
| Claims Payments | 100-200 | Daily |
| Policy | Output supporting the | Annually |
| Declarations/forms | following transaction | |
| | activity: | |
| | 70,720 new policies | |
| | Approx. 70,000 renewals | |
| | Approx. 4900 | |
| | cancellations | |
| | Approx. 66,000 | |
| | amendments | |

The system should have security that provides the ability for insurance carrier to control access to functionality by individual user at an individual function level, e.g. quote or issue. The level of access will be established and maintained by authorized personnel through updates to the Main Application's security profiles.

One exemplary embodiment of the system is described below. First certain terms are defined as follows:
DBR—Detailed Business Requirements
BDS—Business Design Specifications
PPA—Private Passenger Automobile
DG3—Delivery Group 3
IH—Insurance Carrier
LOB—Line of Business
CLUE—Comprehensive Loss Underwriting Exchange
ADD—Additional Driver Disclosure

The exemplary embodiment provides processing and rating of the Private Passenger Automobile (PPA) Line of Business, along with interfaces to ancillary programs, within the Policy Module of the Policy Management System. This exemplary system provides automated rating and underwriting based on IH specific rules, streamline the process for quoting, underwriting, printing and administering a policy, and improve the ability of IH and their agents to analyze data and react appropriately. This exemplary embodiment pertains specifically to the PPA Line of Business.

The detailed business processing requirements of the exemplary embodiment are listed below.
1. The scoping provided for Insurance Carrier Georgia Private Passenger Auto within the Policy Module is as follows:
   a. Company: Southern General Insurance Company
   b. State: GA
   c. Product: PPA
   d. Program: PPA
2. Data entry screens within the Policy Module for the PPA Line of Business.
3. A unique Quote/Application and a unique Policy Number are issued from within. These numbers will be system generated by the system according to the following requirements:

a. Quote Number Assignment—Quotes and Applications will have unique Symbols but will share number assignment. The beginning quote should start with the automatic system assignment of Q00000001 and increment by one with each new quote.
b. Application Number Assignment—If the Application began as a Quote, change the Q Symbol in the quote number to A and continue with the same number. If the Application is new, the Symbol will be an A and the number will be the next available number.
c. Policy Number Assignment—The IH policy number is comprised of a five position prefix identifying the line, state and company, followed by a one position type indicator and ending in a seven position sequential number. The system will automatically generate this policy number. It is not necessary to allow the manual input of a policy number by a system user. Whenever the policy number is printed on a document, it should be displayed with a space between the 5 digit prefix and the last 8 numbers.
1. The system shall assign a 13 digit policy number formatted as follows:
   First two (2) digits would represent the product line:
      15 Private Passenger Auto
      22 Homeowners
      35 Mobile Homeowners
      45 Dwelling Fire
      55 Commercial Auto
      65 Commercial Property
   Next two (2) digits would represent the State/Region code:
      01 Alabama
      10 Georgia
      32 North Carolina
      39 South Carolina
      45 Virginia
      08 Washington DC
   The digit would represent the Company:
      9 Southern General Insurance Company (SGIC)
      8 Southern General Underwriters Insurance Company (SGUIC)
      7 Southern General Indemnity Insurance Company (SGIIC)

For PPA, the 8 digit policy specific number should begin with a 1 if it is a renewal from the Legacy system and 2 if it is new business on the system. The next seven digits should be sequentially issued starting at 0050001. Once the policy number reaches 9999999, the next number would be issued using a 3 as the first digit.
Example: The first new business SG GA PPA policy written in GA would be 1510920050001:
   15—Private Passenger Auto
   10—Georgia
   9—Southern General Insurance Company
   20050001 (Policy Number 1)

The Legacy number schema will not be generated through ACIES but will be generated through the renewal conversion process.
4. Automated rating according to IH requirements as specified in the PPA Rating Specifications.
5. Insurance Carrier offers various pay plan options dependent upon policy type. IH will be provided the ability to enter applicable credit card and EFT account information, although EFT and credit card processing will not be available within the system until DG 4. Entry of an EFT or credit card Payment Method will require the input of additional account information to be used with future Installment EFT transactions. Down Payment will be entered directly into either the Billing Module, the agency Web PPA application or the agency Account Management facility.

a. The Billing Options and Payment Method available for new and renewal business are as follows:

| | |
|---|---|
| New Business Billing Options: | Payment Method: |

| | | |
|---|---|---|
| N1 | Paid in Full | Other |
| N2 | Two Pay | Other |
| N5 | Five Pay | Other/EFT/Credit Card* |

| | |
|---|---|
| Renewal Business Billing Options: | Payment Method: |

| | | |
|---|---|---|
| R1 | Paid in Full | Other |
| R2 | Two Pay | Other |
| R5 | Five Pay (Variable) | Other/EFT/Credit Card* |
| R6 | Six Pay (Variable also) | Other/EFT/Credit Card* |

b. The selection of the Paid in Full Billing Option provides the policy with a discount. It will be necessary for the user to re-rate the policy after this selection in order to view the discounted premium.
C. If the N5 or R5 Billing Option is selected, the user will also have the additional flexibility of entering a Bill Due Date from day 1 to day 28.

This date will be used to specify the day of the month on which each installment payment is due. This date can be up to 14 days prior to the system calculated due date and up to 14 days greater than the system calculated due date.
d. Each Billing Option includes a down payment premium percentage.

The installment requirements shall be defined in the Create/Maintain Pay Plan Table within the Billing Configuration Tables. Selection of the N5 Billing Option provides for a variable down payment percentage based on the existence of two elements of underwriting criteria—Credit Score and Proof of Prior.
The applicable rules used in determining the Down Payment are as follows: For New Business:
   1. If Credit Score for the Named Insured is above 705, the Down Payment is 20%, with the remaining 80% spread evenly across the remaining four installments.
   Else
   2. If Proof of Prior exists with a lapse of less than or equal to 30 days, the Down Payment is 22%, with the remaining 78% spread evenly across the remaining four installments.
   Else
   3. If none of the above applies, the Down Payment is 25%, with the remaining 75% spread evenly across the remaining four installments.
All R5 pay plans shall provide 20% down, with the remaining 80% spread evenly across the remaining four installments (unless the down payment is modified as a result of the variable due date).

If the Bill Due Date entered is greater than the system calculated second installment due date, the calculated Down Payment shall be increased by 0.55% for each day the due date has been extended.
e. It is necessary to provide a view of the applicable installment schedule within PPA via the View Installment button once the Billing Option, Payment Method and Bill Due Date have been entered. The user will need to validate the installment schedule as this is the installment schedule that will be passed to the Billing Module as part of the Policy to Billing XML and used for all installment billing.
6. The system will supply rating worksheets at both the summary and detail level including pro rata premium calculations for amendments. It is the IH requirement that the worksheet shall contain the following data elements:
   a. Quote Effective Date
   b. Policy Term
   c. Insured Name
   d. Coverage Limits
   e. Agency Information
   f. Drivers
      Age
      Sex
      Marital Status
      Class
      Violation Points
      Excluded
      SR-22
      SR-22A
      Citizen
      Handicapped
      Inexperienced
      U/W Tier
      Financial Responsibility Tier
      Market Tier
      All applicable Discounts individually
   g. Vehicles
      Age
      Description
      Territory
      ISO Symbol
      LPMP Class
      Business Use
      Physical Damage Deductibles for each vehicle.
   h. Driver/Vehicle Assignment
   i. Punitive Damage exclusion
   j. Premium for each Vehicle and Coverage type
   k. Coverage Base rates
   l. Payment methods
   m. Disclaimers
   The rating worksheet should also show all of the factors associated with each one of the rating variables above.

7. Premium generated by the Premium Module for PPA should be mapped to the following Line of Business (LOB) coverage designations as shown in Table 3.

TABLE 3

| | | | | | LOB | |
|---|---|---|---|---|---|---|
| Company | Product | Program | Coverage elements | Fee? | Name | State |
| SGIC | PPA | PPA | Bodily Injury | FALSE | Liability | |
| SGIC | PPA | PPA | Property Damage | FALSE | Liability | |
| SGIC | PPA | PPA | Medical Payments | FALSE | Medpay | |
| SGIC | PPA | PPA | Family Financial Help | FALSE | FFH | GA |
| SGIC | PPA | PPA | Uninsured/Underinsured Motorists | FALSE | UM | |
| | | | Bodily Injury | | | |
| SGIC | PPA | PPA | Uninsured Motorists Property | FALSE | UM | |
| | | | Damage | | | |
| SGIC | PPA | PPA | Other Than Collision | FALSE | PhysDam | |
| SGIC | PPA | PPA | Collision | FALSE | PhysDam | |
| SGIC | PPA | PPA | Towing and Labor | FALSE | PhysDam | |
| SGIC | PPA | PPA | Rental Reimbursement | FALSE | PhysDam | |
| SGIC | PPA | PPA | Customizations | FALSE | PhysDam | |
| SGIC | PPA | PPA | SR-22 | TRUE | SR22 | |
| SGIC | PPA | PPA | SR-22A | TRUE | SR22A | |
| SGIIC | PPA | PPA | PIP | FALSE | PIP | DC |
| SGIC | PPA | PPA | PIP | FALSE | PIP | SC, VA |
| SGIC | PPA | PPA | APIP - Medical Expense | FALSE | PIP | SC |
| SGIC | PPA | PPA | APIP - Extra Medical Expense | FALSE | PIP | VA |
| SGIC | PPA | PPA | PIP Work Loss Benefit | FALSE | PIP | VA |

8. In addition to the worksheet, the system will supply the required IH PPA documents as specified in the PPA Output BDS document.
9. IH has contracted to use an underwriting tool to provide the liability and physical damage symbols. In addition, the underwriting tool provides the ability to update data regarding vehicle descriptions and specifications in the underwriting of their private passenger auto program. The system will validate whether the VIN number entered is valid. If the VIN number entered is valid, the system will populate the vehicle description, optional equipment and symbol information in the appropriate fields. Should the system return that the entered VIN number is not valid the User will be notified and can select the ? button which follows the VIN number field, this will allow the user to enter the Year and Make of the vehicle for the look-up. If the VIN was not able to be validated and the user wanted to accept the VIN, the system will track this item and generate the appropriate memo. The models and body types associated to the year and make will be displayed in drop down boxes for selection.
   The following information will be retained by the system even though there are no specific fields on the vehicle screen:
      a. County Wide Performance
      b. Special Vehicle Group
      c. Four Wheel Drive Indicator
      d. Engine Cylinders
      e. Engine Type
      f. Engine Size
      g. Special Information
      h. Model Series Information
      i. Body Information
      j. Engine Information
      k. Restraint Information
      I. Transmission Information
      m. Not Classified Info

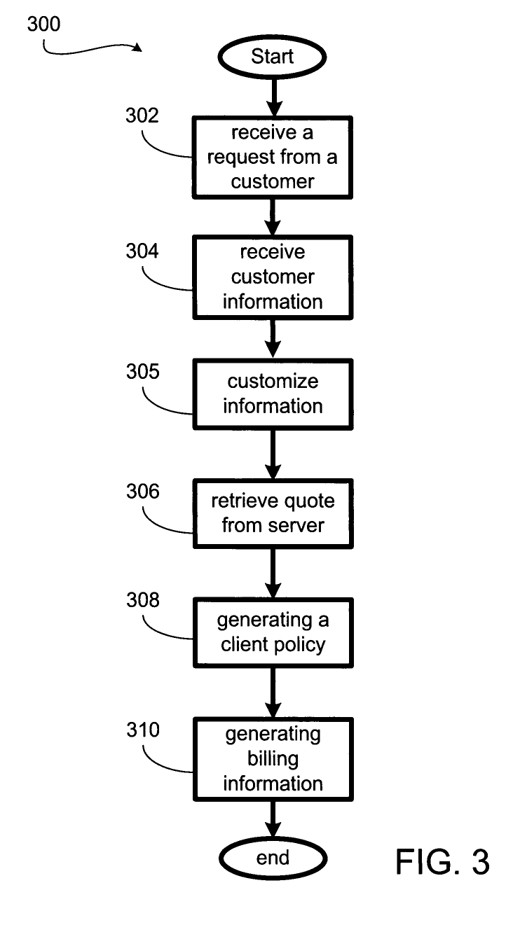

The improved insurance quoting and underwriting process described above can be summarized through an exemplary client process of FIG. 3. When a customer needs an insurance service, the customer approaches an insurance agent, step 302. The insurance agent takes customer information and input it into the client application resident on a client terminal at the insurance agent's office, step 304. The customer information is used to retrieve a quote from a remote server, step 306. The customer information may be customized according to core policies, step 305, before being sent to the remote server and used to generate a customized client policy, step 308. The customized client policy is used to generate a customized bill, step 310. The customized client policy is also used later to handle claims and customizing the claims.

While there has been shown a preferred embodiment of the present invention, it is to be appreciated that certain changes can be made in the form and arrangement of the elements and steps of the method without departing from the underlying spirit and scope of the invention.

What is claimed is:

1. A system for improving insurance quoting and underwriting, the system interfacing with a remote server, the system comprising:
a policy administration module for implementing core policies and client customization and outputting a client policy;
a billing module for generating a bill to each client according to the client policy;
a claims module for processing claims according to core claims features, the claims module further being capable of customizing according to each individual client policy; and
an interface module for sending and receiving information from the remote server.

2. The system of claim 1, further comprising a reinsurance module for implementing reinsurance.

3. The system of claim 1, wherein the policy administration module further being capable of providing automated rating.

4. The system of claim 3, wherein the policy administration module further being capable of displaying rating information to a user.

5. The system of claim 1, wherein the billing module further being capable of agency billing, direct billing, and account billing.

6. The system of claim 1, wherein the claims module further being capable of litigation tracking.

7. A method for improving insurance quoting and underwriting, the method comprising the steps of:
receiving customer information;
customizing customer information according to core policies;
outputting a client policy; and
generating a bill according to the client policy.

8. The method of claim 7, further comprising the steps of:
Transmitting customer information to a remote server; and
retrieving a quote information from the remote server.

9. The method of claim 7, further comprising the steps of:
generating a rating information; and
displaying the rating information.

10. The method of claim 7, wherein the step of generating a bill further comprising the steps of:
generating an agency bill;
generating a direct bill; and
generating an account bill.
